(19) United States
(12) Patent Application Publication
(10) Pub. No.: US 2012/0107759 A1
(43) Pub. Date: May 3, 2012

(54) FLAMELESS IMPINGEMENT PREHEATING FURNACE

(76) Inventor: Christopher Moran, University Heights, OH (US)

(21) Appl. No.: 12/913,113

(22) Filed: Oct. 27, 2010

(51) Int. Cl. F27D 7/00

(52) U.S. Cl. 432/207

(57) ABSTRACT

A heating apparatus for charge material includes a preheater having a housing with a combustion chamber therein constructed and arranged to receive the charge material, at least one oxy-fuel burner mounted to the housing for providing a combustion flame to the combustion chamber wherein a combustion atmosphere is created to provide heat sufficient to increase a temperature of the charge material, a fuel supply and an oxidant supply connected to the at least one oxy-fuel burner, an exhaust in communication with the combustion chamber for removing a portion of the combustion atmosphere from the combustion chamber; and a melter separate from the preheater for coaction therewith to receive the heated charge material for being melted in the melter.

The present embodiments relate to apparatus and methods for preheating charge materials to be subjected to a heating or melting operation.

In a melting or reheating furnace, a lower and more uniform flame temperature will reduce the likelihood of overheating the charge material, reduce the formation of oxides of nitrogen (NOₓ) and the formation of metal oxides (scale or dross), increase furnace throughout, and reduce furnace fuel consumption, due to an improved heat transfer mechanism.

Fossil fuel melting furnaces for aluminum and copper utilize energy released from a flame to raise the temperature of the charge material and the furnace superstructure (which consists of a refractory lining and steel structure). Air-fuel fired furnaces are fairly inefficient, with only about 20-30% of the gross energy released going to the charge material during the melt portion of the furnace cycle. The remainder of the gross energy is used to heat the superstructure, or lost through to the furnace exhaust.

Air-fuel systems that utilize preheated combustion air offer a significant improvement over “cold” air systems. Preheating the combustion air can result in furnace efficiencies of approximately 30-40%. The primary drawbacks to preheated air-fuel systems are equipment cost, footprint and ongoing equipment maintenance.

Oxy-fuel fired furnaces are a significant improvement over conventional air-fuel furnaces as described above. Due to the elimination of nitrogen in the oxy-fuel process, the amount of energy lost to the furnace exhaust is significantly reduced. As a result, with an oxy-fuel based melting furnace, approximately 35-50% of the gross energy input is used to heat the charge material.

FIG. 1 shows a known melting operation wherein the charge material is, for example, in one or more of the forms or structures indicated, and is provided to a furnace, such as a reverberatory furnace, for melting to produce a cast or molten product for subsequent use or application.

### SUMMARY OF THE INVENTION

The flameless impingement preheating furnace embodiment (“preheater”) is used in conjunction with melting furnaces. The preheater is a relatively small stand alone furnace that utilizes oxy-fuel. The furnace heats the charge material (sow, t-bar, bundled ingots, etc. of various sizes and shapes) to a temperature that is below its solid-to-liquid transition point. Once heated to the desired temperature, the charge material is transferred to the melting furnace where the remainder of the melting process is carried out.

The preheater embodiment heats material more efficiently than a conventional air-fuel or oxy-fuel furnace. Specifically, the preheater will raise the material temperature more quickly and utilize less energy than conventional cold and hot air-fuel or conventional oxy-fuel processes. The preheater operated in combination with a conventional melting furnace will result in greater net furnace efficiency, and also offers greater melting operation flexibility.

From a safety perspective, the preheater furnace embodiment will thoroughly dry the charge material prior to it being charged to the melting furnace. Moisture present in any porous section of the charge material may increase the risk of a steam bubble(s) submerged in molten metal within, for example, a reverberatory furnace. Steam trapped below the molten surface is a common cause of explosions that result in injury and equipment damage.

### BRIEF DESCRIPTION OF THE DRAWINGS

For a more complete understanding of the present embodiments, reference may be had to the following drawing figures taken in conjunction with the description of the embodiments, of which:

FIG. 1 is a flow chart of a known melting operation.

FIG. 2 is a flow chart of a melting operation using a flameless impingement preheating furnace embodiment of the present invention.

FIG. 3 is a schematic view in partial cross-section of the flameless impingement preheating furnace embodiment of the present invention.

FIG. 4 is a schematic view in cross-section taken along line 4-4 of FIG. 3.

### DETAILED DESCRIPTION OF THE INVENTION

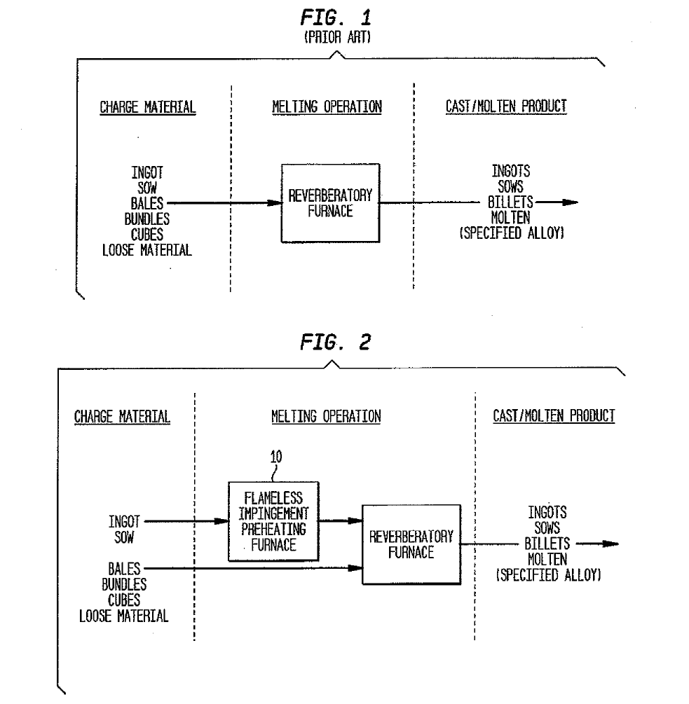

Referring to FIG. 2, the preheater furnace embodiment of the present invention shown generally at 10 is added to or used in conjunction with a known melter. The preheater 10, when combined with a conventional melting furnace, provides production flexibility in terms of a) the ability/option to heat the scrap in the preheater rather than in the melting furnace, and b) the ability to heat charge material in the preheater while at the same time heating material in the conventional melting furnace, thereby increasing the production capacity of the facility (in other words, expanding the operating window).

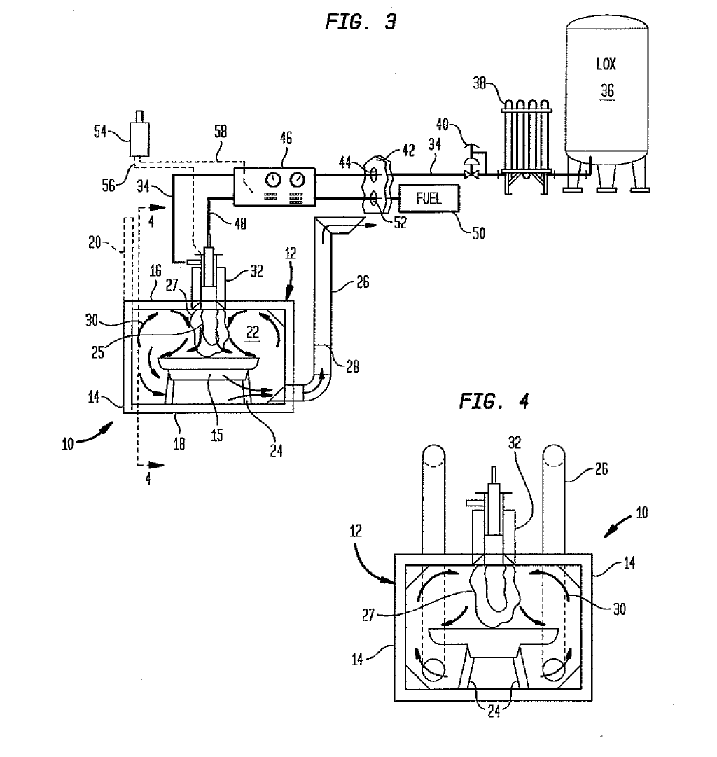

Now referring to FIGS. 3 and 4, the preheater furnace embodiment 10 is shown for use with conventional melting furnaces (not shown). The preheater 10 includes a housing 12 which may have a plurality of side walls 14 depending upon the shape of the housing 12. A top 16 or crown and a bottom 18 or floor is provided for the housing 12. One of the side walls 12 is provided with a door 20 which is moveable to permit charge material, such as for example aluminium ingots or aluminium sows, to be introduced into a combustion chamber 22 of the preheater 10. The sidewalls 14, top 16 and bottom 18 define the combustion chamber 22 within the housing 12.

Disposed within the combustion chamber 22 is at least one or a plurality of support members 24 such as for example stanchions to support charge material 15, such as an ingot or sow, in the combustion chamber 22 for heating thereof. An exhaust 26 or a plurality of exhausts is/are in communication with the combustion chamber 22 of the preheater 12, the exhaust 26 including a damper 28 disposed at an interior of the exhaust 26 to control pressure of the preheater 12.

The charge material 15 is subjected to the circulatory combustion atmosphere represented generally by arrows 30.

The preheater includes one or a plurality of the burners 32 mounted to the top 16 of the preheater 12, such as for example an oxy-fuel burner 32. The burner 32 is in communication with the combustion chamber 22 to provide a flameless impingement heat source 25 for heating the charge material 15. The heat source 25 provides a flame envelope 27 which includes the atmosphere and combustion products circulating in the combustion chamber 22. Oxygen as an oxidant for the burner 32 is provided from a pipe 34 which is at one end connected to the burner 32 and at distal end ultimately in communication with a liquid or gaseous oxygen source 36 such as a tank, vessel or oxygen generating machine. The burner 32 or burners may also be disposed in the sidewall 14 for communication with the combustion chamber for combustion therein.

Tracing the line 34 from the source 36, the line 34 passes through a vaporizer 38, after which a pressure relief valve 40 is interposed at the line 34.

While the preheater 10 may be disposed in its own separate lot or building for use with a melter such as a reverberatory furnace, the source 36, vaporizer 38 and valve 40 will probably be disposed external to the building in which the preheater 10 is arranged and therefore, a wall represented generally at 42 is provided with a port or aperture 44 through which the line 34 may pass to be connected to a control system 46 having valves and meters for control and metering of the liquid oxygen to the burner.

A fuel line 48 is also provided having one end in communication with the burner 32 and a distal end in communication with a fuel source 50. The line 48 connecting the fuel source 50 with the burner 32 is also connected to the controller 46 for the necessary valving and metering with respect to the fuel control to the burner 32. A port or aperture 52 is also provided in the wall 42 to accommodate the fuel line 48, as the fuel source 50 will be remote from the preheater 10. The fuel from the fuel source 50 can be selected from natural gas, propane and oil, for example.

A control panel 54 is connected to the burner 32 by line 56, and to the control system 46 by line 58.

The preheater 10 may be operated above 300° F. (149° C.), and with aluminium and other metals from 700° to 800° F. (371° to 427° C.). The preheater 10 is not used to actually melt the charge material, but rather to elevate the temperature of the charge material 15 such that it is more receptive and closer to its melting temperature in the melting furnace.

The charge material 15 is loaded into the preheater 10 through the door 20 by for example a forklift. It is common for the charge material 15 to be constructed such that it is readily accessible by a forklift or other mechanical conveying means. After the charge material 15 has reached the necessary preheating temperature in the preheater 10, the forklift will remove or extract the material 15 through the door 20 from the combustion chamber 22 and deposit same in the melting furnace.

Aluminium for example will become molten when it reaches a temperature just over 1,200° F. (649° C.). Therefore, heating the aluminium charge material 15 to a temperature between 700 to 800° F. (371° to 427° C.) will substantially reduce the residence time of the charge material 15 in the melting furnace. This will also lead to a reduction in the use of fuel and oxidant that the melting furnace would otherwise have to use to elevate the aluminium charge material 15 to reach its molten state.

By way of example only, the preheater 10 may have dimensions of approximately 6 feet (1.8 meters) in length, 4 feet (1.2 meters) in width and 5 feet (1.5 meters) in height.

The preheater 10 is oriented such that when fired the flame envelope 27 is in contact with the surface of the material to be preheated. The direct contact of the flame envelope results in effective heat/energy transfer.

The small, refractory lined preheater 10 provides the top for the burner flame 25. The unoccupied interior furnace volume (combustion chamber 22 volume minus charge material 15 volume) is relatively small. The small volume and the atmosphere circulation 30 in the combustion chamber 22 create combustion atmosphere velocities that produce convective heat transfer to the surfaces of the charge material 15 not being directly impinged upon by the flame 25.

The products of combustion present in the unoccupied combustion chamber 22 volume (or furnace interior volume minus the charge material 15 volume) are recirculated into the flame envelope 27.

The preheater operates 10 in a semi-flameless mode, wherein the flame is still visible (hot) to a combustion system UV detector, but flameless (cool) enough to maintain a flame temperature that is low enough not to cause melting of the charge material 15 surface.

The heat transfer effect of the preheater 10 results in the ability to more quickly raise the temperature of the charge material 15 which results in faster melting processes and improved overall manufacturing efficiencies (increased throughput, reduced specific labor cost, reduced specific overhead cost, etc.).

The flameless direct flame impingement, along with the compact preheater 10 dimensions results in reduced fuel consumption when compared to currently available technologies. Specific fuel consumption pertains to the amount of energy consumed to raise a prescribed amount of material to a given temperature.

The preheater 10 is a relatively low cost solution to incrementally increase the production capacity of a given melter facility. In other words, having reached a production limit on a given melter furnace, the furnace operator may elect to build a new melting or holding furnace, but the justification for such a large investment is often challenging and may result in a significant level of risk. The preheating 10 requires a lower capital investment and offers a more manageable level of risk.

Steel, aluminum and copper for example can be heated by the preheater 10.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. A heating apparatus for charge material, comprising:
a preheater comprising a housing having a combustion chamber therein constructed and arranged to receive the charge material, at least one oxy-fuel burner mounted to the housing for providing a combustion flame to the combustion chamber wherein a combustion atmosphere is created to provide heat sufficient to increase a temperature of the charge material, a fuel supply and an oxidant supply connected to the at least one oxy-fuel burner, an exhaust in communication with the combustion chamber for removing a portion of the combustion atmosphere from the combustion chamber; and
a melter separate from the preheater for coaction therewith to receive the heated charge material for being melted in the melter.

2. The heating apparatus of claim 1, wherein the at least one oxy-fuel burner is mounted to a crown of the housing.

3. The heating apparatus of claim 1, further comprising a support assembly disposed in the combustion chamber of the housing for supporting the charge material.

4. The heating apparatus of claim 1, wherein the fuel supply comprises fuel selected from natural gas, propane and oil.

5. The heating apparatus of claim 1, wherein the oxidant supply comprises oxygen.

6. The heating apparatus of claim 1, wherein the combustion atmosphere can reach a temperature of at least 800° F. (427° C.).

7. The heating apparatus of claim 1, further comprising control means in communication with the fuel supply, the oxidant supply and the at least one oxy-fuel burner for controlling amounts of the fuel and oxidant supplies to the burner for the combustion flame.

8. The heating apparatus of claim 1, wherein the melter comprises a reverbatory furnace.

9. The heating apparatus of claim 1, wherein the housing further comprises a door operable for loading the charge material into the combustion chamber, and for removing the charge material from the combustion chamber.

10. The heating apparatus of claim 1, wherein the charge material comprises at least one of aluminum, steel and copper.
